(19) United States
(12) Patent Application Publication
(10) Pub. No.: US 2010/0293232 A1
(43) Pub. Date: Nov. 18, 2010

(54) Unified Messaging Accessibility Architecture

(75) Inventors: James Jackson, Austin, TX (US); Mehrad Yasrebi, Austin, TX (US)

Correspondence Address: AT & T Legal Department - WS;Attn: Patent Docketing, Room 2A-207, One AT & T Way, Bedminster, NJ, 07921, US

(73) Assignee: AT&T Intellectual Property I, LP, Reno, NV (US)

(21) Appl. No.: 12/464,564

(22) Filed: May 12, 2009

(51) Int. Cl. G06F 15/16

(52) U.S. Cl. 709/206

(57) ABSTRACT

A system and method for depositing and retrieving message using an accessibility service, such as TTY, within a unified messaging platform. A unified messaging platform is configured to receive accessibility service signals and convert those signals into a text-based encoding that is then stored as a message within the unified messaging platform for later retrieval. The unified messaging platform is further configured to retrieve messages and re-encode the message into a format compatible with the accessibility service. Audio recordings can be converted to a text-encoding via an automated speech recognition module, and text encodings can be converted to accessibility signals, which are transmitted to the user of the accessibility service.

### BACKGROUND OF THE INVENTION

This invention relates generally to a unified messaging platform (UMP), and more specifically to methods and an apparatus for providing accessibility services within a unified messaging platform.

Unified messaging is the integration of different streams of communication (e.g., email, voicemail, short message service (SMS), fax, etc.) into a single, unified message store (e.g., a unified messaging platform) that is accessible from a variety of user devices. These different streams of communication are provided by a variety of devices such as telephone, cell-phone, computer, and fax machine each having a protocol for accessing and communicating with the unified messaging system.

Despite the proliferation of computer access to unified messaging systems through e-mail and instant messaging, teletype (TTY) devices continue to be used by a significant number of people. Presently, no system exists for interfacing these TTY devices with a unified messaging system. A TTY device, which is also known as a telecommunications device for the deaf (TDD), is an accessibility device that enables text-based communication over a telephone line. Such devices are typically used when one or more of the parties to a call have hearing or speech difficulties.

TTY devices typically include a keyboard and a display. A user of a TTY device can send a message to another TTY-device user by entering text using the keyboard. The text is then encoded via a known protocol, including but not limited to Baudot code, EDT, DTMF, V.21, or V.23. The encoded signal is transmitted over the public switched telephone network (PSTN) from the sending TTY device to the receiving TTY device. The TTY device receiving the encoded signal then decodes the signal using the same protocol used for the encoding process to obtain the sent text message. The text message is then displayed on the TTY device.

Presently, a TTY device can not readily accomplish the simple task of creating and depositing a message in a unified messaging system. A TTY-user may not be able to hear the audio prompts of the messaging system, and therefore would not know when to start leaving a message or what keys to press to navigate the menus of the messaging system. Additionally, even if the TTY-user was able to record a message, the message would be stored as a series of audio tones that could be corrupted depending on the codecs used by the system. Retrieval of a message presents similar difficulties and deficiencies. TTY-users may not be able to hear or understand audio recorded messages, and non-TTY users will not be able to understand a message recorded by a TTY-user, because the message will be the series of recorded tones.

Accordingly, improvements in the unified messaging platform would be beneficial.

### BRIEF SUMMARY OF THE INVENTION

In accordance with one aspect of the present invention, a system for providing accessibility services within a unified messaging platform is provided. The system includes a gateway for communicating with a network and a switch that routes communications between the users of the network. The system further includes a storage device of a Telephony User Interface (TUI) system. The TUI system is configured to allow a user of an accessibility service to create a message in the unified messaging platform. The TUI receives a series of accessibility signals from the user and converts those signals into a text encoding, which is stored as a message in the storage device.

In a further aspect of the present invention, the TUI can retrieve audio messages for a user of the accessibility service. After retrieving the message from the storage device, the TUI can examine the encoding of the message. If the message includes an audio component (e.g., voice recording), the TUI can utilize an automated speech recognition module to convert the audio into a text encoding. The text encoding can then be rendered and transmitted to the user.

The present invention also provides a method of creating a message using an accessibility service within a unified messaging platform. A request to create a message is received at the unified messaging platform from a user (i.e., caller) for another user (i.e., the “callee” or the “target”). The unified messaging platform receives a series of accessibility service signals from the caller and detects one or more of the signals. In response to detecting the accessibility signal, the series of accessibility signals are converted into a text encoding that can then be stored in a storage device of the unified messaging platform.

In yet a further aspect of the present invention a method of retrieving messages using an accessibility service within a unified messaging platform is provided. The unified messaging platform receives a retrieval request for a message from a user. The unified messaging platform determines whether the user is subscribed to an accessibility service and retrieves the message from the storage device of the unified messaging platform. The unified messaging platform then determines whether the message is encoded in a format associated with the accessibility service, renders the encoded message, and transmits the rendered message to the user.

These and other advantages of the invention will be apparent to those of ordinary skill in the art by reference to the following detailed description and the accompanying drawings.

### BRIEF DESCRIPTION OF THE DRAWINGS

FIG. 1 depicts an exemplary network environment providing a unified messaging platform in accordance with an embodiment of the present invention;

FIG. 2 is a flow diagram of a call flow for depositing a message using an accessibility service in a unified messaging environment in accordance with an embodiment of the present invention;

FIG. 3 is a flow diagram of a call flow for retrieving a message using an accessibility service in a unified messaging environment in accordance with an embodiment of the present invention; and

FIG. 4 depicts an exemplary computer system in accordance with an embodiment of the present invention.

### DETAILED DESCRIPTION OF THE INVENTION

The present invention is directed to providing accessibility services within a unified messaging platform. Although the present invention is described herein with respect to a TTY-based accessibility service, it would be understood by one of ordinary skill in the art that the present invention is not limited to TTY protocols and devices, but may be applied to various accessibility services provided in a unified messaging platform environment.

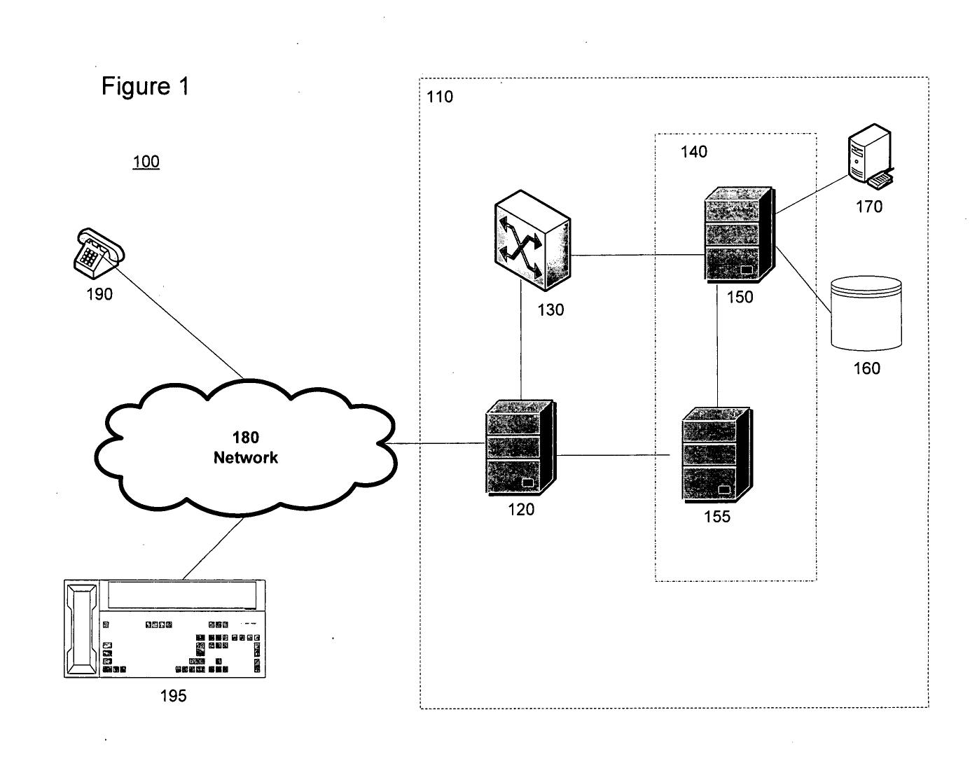

FIG. 1 depicts an exemplary network environment 100 including a unified messaging platform 110 in accordance with an embodiment of the present invention. The unified messaging platform 110 includes a border element 120 (e.g., gateway) that enables the unified messaging platform 110 to communicate with a network 180. The network 180 can include the Internet, a public switched telephone network (PSTN), or any other network. The network 180 connects user telephonic devices including telephony devices 190 (e.g., conventional telephones, Voice over IP (VoIP) phones, and VoIP analog telephony adapters (ATAs)) and TTY-enabled devices 195. The border element 120 is configured to interface with various networks and convert between different communication protocols (e.g., between voice over IP (VoIP) and time-division multiplex (TDM)) used in various subnets of the network. The unified messaging platform also includes a switch 130 that appropriately routes calls from the network 180. The switch 130 is preferably a softswitch capable of connecting calls from one device to another using a software system. The border element 120 and the switch 130 can communicate through various signaling protocols, including Session Initiation Protocol (SIP), Media Gateway Controlled Protocol (MGCP), and H.248, etc.

The unified messaging platform 110 further includes a Telephony User Interface (TUI) 140. The TUI 140 preferably includes an Application Server 150 and a Media Server 155. The media server 155 is configured to process media (e.g., Real-time transport protocol (RTP) audio, text events, and dual-tone multi-frequency (DTMF) events, etc.) received from the border element 120 or the application server 150. The media server 155 and the application server 150 typically communicate via signaling protocols such as the Session Initiation Protocol (SIP) and Voice XML (VXML).

The TUI 140 communicates with a storage device 160 and a directory 170, preferably through the application server 150. The storage device 160 includes a computer readable medium such as a disk drive, solid state memory, flash memory, or other electromagnetic memory, or an optical storage device. The storage device 160 is used to store messages within the unified messaging platform 110 and preferably provides access by way of a known storage access system model such as a database, structured file system, or e-mail server. A storage device 160 that is configured to store messages within the unified messaging platform 110 as e-mail messages is preferably accessed by the application server 150 via Internet Message Access Protocol (IMAP) or Simple Mail Transfer Protocol (SMTP). The directory 170 is preferably accessed using a Lightweight Directory Access Protocol (LDAP) and stores information concerning the users of the system.

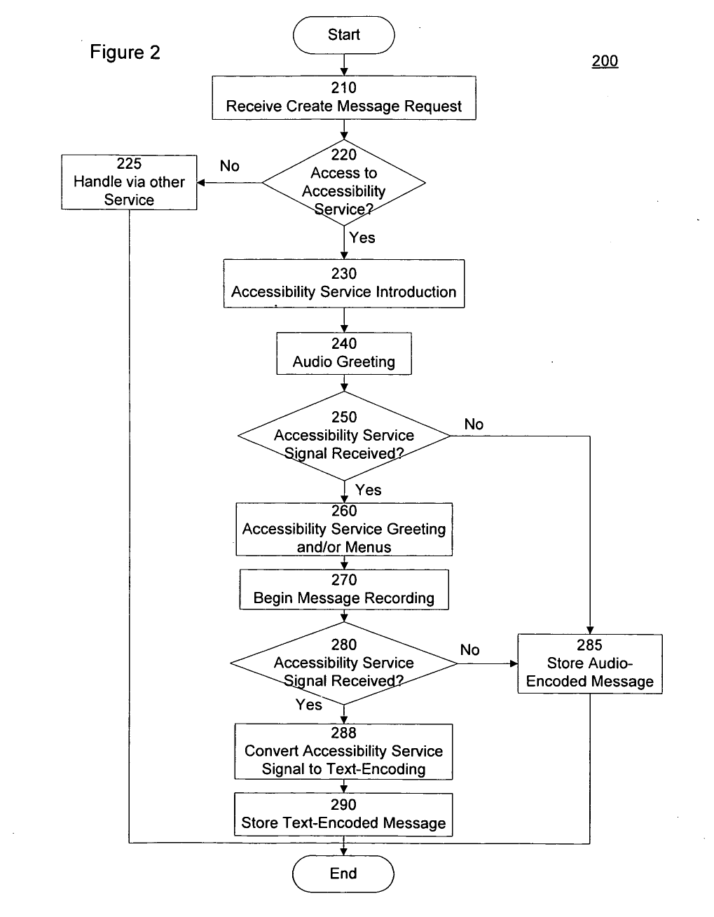

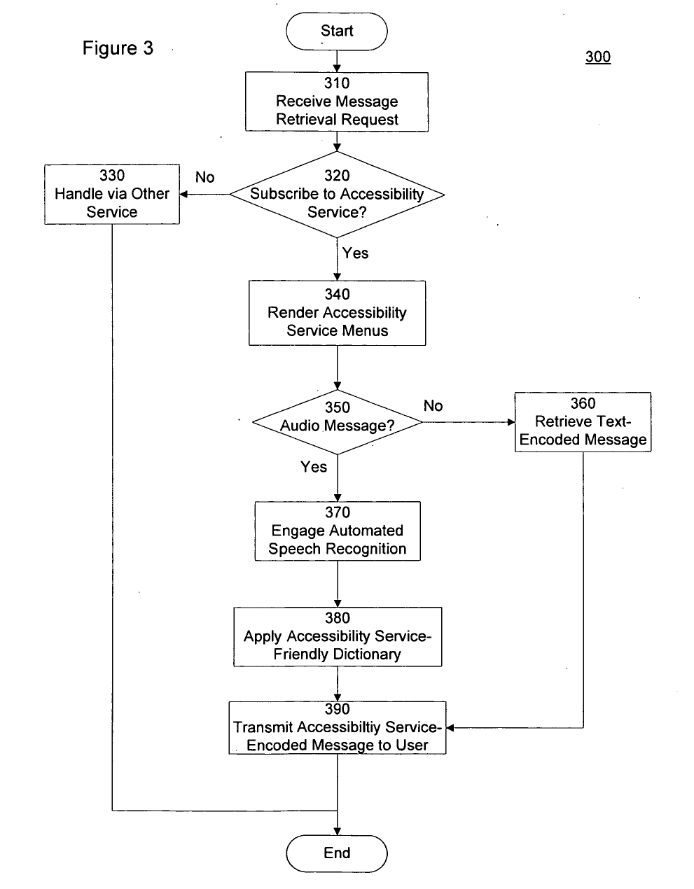

As described below with respect to FIGS. 2 and 3, the various features and aspects of the present invention can be implemented and provided within the exemplary unified messaging platform 110 illustrated and described with respect to FIG. 1. Furthermore, it would be recognized by one of ordinary skill in the art that the unified messaging platform 110 illustrated in FIG. 1 can be modified to operate as a monolithic system having an individual server executing the various operations of the unified messaging platform. Alternatively, the unified messaging platform 110 can be implemented as a distributed system that is scaled to service a large number of users having various and dispersed network connections.

In accordance with one aspect of the present invention, the unified messaging platform 110 illustrated in FIG. 1 can be configured to allow a user of an accessibility service, such as a TTY device, to create and deposit a message within the unified messaging platform 110. FIG. 2 is a flow diagram according to an embodiment of the present invention illustrating a process 200 by which a caller can deposit a message.

At step 210, the unified messaging platform receives a request from a user to create a message. Typically, this request is created when a user places a call that is not answered by the receiving party, and after a pre-determined length of time or number of rings, the caller is connected with a messaging service of the unified messaging platform 110. Alternatively, the caller can directly call the messaging service of the unified messaging platform 110 and indicate a desire to deposit a message for a particular party.

At decision 220 the system determines whether the user placing the call (i.e., the caller) and/or the party receiving the call (i.e., the target) has access to the TTY class of service (e.g., subscribed to TTY service). Preferably, the system retrieves information from directory 170 to determine which classes of service are subscribed to by the caller and/or target. If neither party is subscribed to the TTY service, the caller can be handed off to another class of service at step 225, such as standard voicemail, for depositing a message. Alternatively, if the caller is not subscribed to the TTY service, the caller can be allowed access to the service for only this particular call, or for a predetermined period of time, for a fee that is agreed to by the caller as part of the message deposit process. In yet a further alternative, the system can be configured to always provide TTY service to a caller and only require the target to subscribe to the TTY service, or agree to a onetime payment for the service.

Optionally, at step 230, the caller can be presented with an introductory message indicating the option of using the TTY message service. If the caller has already been verified as a TTY service subscriber, the prompt at step 230 can be rendered via the TTY service. Alternatively, or in addition to the TTY prompt at step 230, a standard audio greeting can be rendered at step 240.

At step 250, the unified messaging platform 110 determines whether a TTY-event (i.e., accessibility service signal) has been received. Receipt of a TTY-event can indicate that the caller desires to use the TTY service. Optionally, a specific predetermined TTY-event, or series of TTY-events, can be used to indicate the desire to use the TTY-service. For example, the unified messaging platform 110 can monitor for and detect a TTY-event corresponding to a “y” or the string “tty” to trigger a switch to the TTY messaging service. Alternatively, the unified messaging platform 110 can provide the TTY messaging service upon detecting any TTY event. In this manner, the user merely needs to press a single TTY key to inform the unified messaging platform that the message will be created using the TTY service.

At step 260, the unified messaging platform 110 can render a text-based greeting using the TTY service, for example as an acknowledgment that the TTY messaging service will be used or to provide instructions to the caller via the TTY service. In a further aspect of the present invention, at step 260, the unified messaging platform 110 can also display a series of menu choices via the TTY service and request a selection from the caller so as to enable the caller to navigate various options provided by the TTY messaging service.

At step 270 the unified messaging platform 110 begins the recording phase of the service. A TTY user can leave either a voice/audio message or a TTY message. Thus, at step 280 it is determined whether the unified messaging platform 110 has detected a TTY-event indicating the desire to leave a TTY message. If not, the unified messaging platform 110 can record an audio message (i.e., conventional voicemail) at step 285. However, if at step 280, it is determined that the system has detected a TTY-event, the caller can create the message via the TTY service. Accordingly, the unified messaging platform 110 monitors the audio communications with the caller for a series of TTY-events that comprise the message being created by the caller. The TTY-events are then converted to a text encoded message at step 288 and are stored in the device storage 160 at step 290.

It should be noted that the TTY-user can be provided with the separable options of navigating the messaging menu system via a series of rendered TTY messages and recording a message using the TTY service. That is, at step 250, the unified messaging platform 110 determines whether a TTY-event has been received so as to indicate whether the messaging system menus should be rendered via the TTY service. At step 280, the unified messaging platform 110 can independently determine whether the unified messaging platform 110 has detected a TTY-event indicating the desire to record a TTY message. Thus, the unified messaging platform 110 can render menus via the TTY service and record a voice/audio message. Alternatively, the unified messaging platform 110 can render audio menus and record a TTY message. In yet a further alternative, the messaging system menus can be rendered and navigated via the TTY service and the message can be recorded by the TTY service.

The foregoing combination of operations can be determined by a configuration of the unified messaging system 110. For example, unified messaging system 110 can be configured to determine whether to render the messaging system menus independently of the determination of whether to record the message via the TTY service. Alternatively, the unified messaging system 110 can be configured such that if a TTY-event is detected at step 250, the system will automatically record the message using the TTY service (i.e., the system will not check for a TTY-event at step 280).

As discussed above, the TTY-events that comprise the message from the caller are typically encoded as audio tones. In one aspect of the present invention, at step 288 the border element 120 converts each TTY-event, encoded for example in DTMF, into the associated text character(s). The text character(s) are then encoded in an RTP event encoding that is transmitted to the TUI 140, where the events comprising the message are aggregated and stored in the storage device 160.

It should be further noted that the TTY-service can be configured such that any TTY-event(s) detected at step 250 (i.e., the TTY-event indicating the caller's desire to user the TTY messaging service) can be included in the message being created by the caller. In this manner, the caller using the TTY service can simply begin entering the message for the target without regard to audio prompts from the messaging service that may not be heard by the caller.

Alternatively, the TTY-event(s) detected at step 250 can be excluded from the message. In this configuration, the unified messaging platform 110 preferably renders a TTY-based greeting or TTY-based instructions and/or menu at step 260 to coordinate when the caller should begin entering the message.

While process 200 of FIG. 2 depicts a flow diagram for creating a message using an accessibility service (e.g., TTY service), in accordance with an embodiment of the present invention, the unified messaging platform 110 also enables a user of the TTY messaging service to retrieve message that were created using the TTY service or a conventional audio-based voicemail service.

FIG. 3 is a flow diagram of a process 300 for retrieving a message using an accessibility service in a unified messaging platform 110 according to an embodiment of the present invention. At step 310, the unified messaging platform 110 receives a request to retrieve message from a user (i.e., the caller) of the unified messaging platform. Typically, the caller places a call to a designated voicemail phone number that connects the caller to an Interactive Voice Response (IVR) system or an Automated Attendant (AA) system. The IVR or AA provides the caller with a series of user-interactive menus that allow for caller navigation by voice command or keypad input. However, as described below, in one aspect of the present invention, a user of an accessibility service (e.g., TTY service) can navigate and retrieve messages using the features provided by the accessibility service.

The system can then retrieve information from directory 170 about the caller requesting message retrieval, particularly whether the caller is subscribed to the TTY service. At decision 320, the system can determine whether the caller is subscribed to the TTY service. If the caller is not subscribed the accessibility service, the system redirects the caller for processing by a different class of service at step 330, such as a standard audio-based voicemail service.

If, however, the caller is subscribed to the TTY service, the unified messaging platform 110 begins communicating with the caller via TTY messages, for example by rendering accessibility service menus at step 340. In a further feature of the present invention, the unified messaging platform 110 renders TTY messages that provide a navigation menu (e.g., a text based menu that corresponds to the conventional voice prompts of an audio-based voicemail service) and assist the caller with retrieving the desired message. Optionally, it can be desirable to wait for an indication from the caller that TTY-messaging services are desired. This indication can include detection of any TTY signal sent by the caller or a specific TTY signal(s), similar to the TTY-event monitoring process discussed above with respect to step 250 of FIG. 2.

The caller then requests the retrieval of a particular message, and at step 350 the system determines a format or an encoding of the message. If the message is a text encoded message, the system retrieves the message at step 360 and renders the message in a format understood by the caller's accessibility device at step 390 (e.g., transmits a TTY encoding of the message to the caller's TTY device). For example, if the message requested at step 350 is an SMS message stored in the unified messaging platform 110, the unified messaging platform 110 retrieves the message at step 360, converts it to a TTY encoded message, and transmits the message to the caller's TTY device at step 390. In a further example, if the message requested at step 350 was created using process 200 that was discussed with respect to FIG. 2, the system will determine the message is in a text-based encoding and proceed with steps 360 and 390.

However, if the message requested is determined at step 350 to be an audio recording, the unified messaging platform can engage an Automated Speech Recognition (ASR) module at step 370. The ASR module is used to convert the audio message to a text-encoded message. The ASR module can be hosted by a separate server, or it can be a software module that is executed by one of the computers already operating within the unified messaging platform 110.

Optionally, the text message can be further processed before being transmitted to the caller. For example, at step 380, the unified messaging platform can utilize a TTY-friendly dictionary that converts various words and phrases based on spelling conventions and acronyms commonly used by TTY.

At step 390 the retrieved message that is now in a text-based encoding, and is preferably converted and formatted according to conventions of the accessibility service, is transmitted to the caller and rendered as a TTY message. Thus, an audio (i.e., voice) message deposited by a user can be retrieved and understood by a caller requiring accessibility services, such as TTY services.

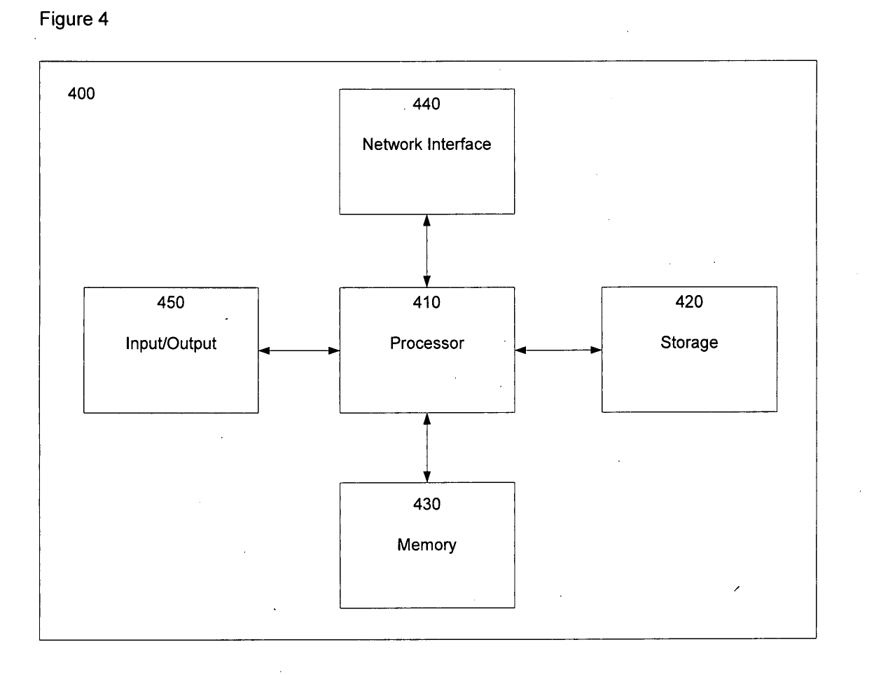

In accordance with one embodiment of the present invention, various aspects of the invention can be implemented using a computer system. FIG. 4 illustrates a high level block diagram of a computer 400. For example, one of ordinary skill in the art would understand that process 200 illustrated in FIG. 2 and process 300 illustrated in FIG. 3 can be implemented via computer programs executing within a computer 400 or implemented within the computer components and hardware described in FIG. 4.

Computer 400 contains a processor 410 that controls the overall operation of computer 400 by executing computer program instructions defining the operations. The computer program instructions can be stored in a storage device 420 (e.g., magnetic disk) and loaded into memory 430 when execution of the computer program instructions is desired. Thus, a computer program is defined by the instructions stored in memory 430 and/or storage 420, and the computer 400 is controlled by processor 410 executing the instructions. Preferably, computer 400 also includes one or more network interfaces 440 for communicating with other devices via a network. Computer 400 can also include one or more input/output modules 450, which represent devices that allow for user interaction with the computer 400 (e.g., display, keyboard, mouse, speakers, buttons, etc.).

One skilled in the art will recognize that an implementation of an actual computer can contain other components as well, and that FIG. 4 is a high level representation of some of the components of such a computer for illustrative purposes. Such computers are well known in the art, and can be implemented, for example, using a well known computer processors, memory units, storage devices, computer software, and other components. The aforementioned computer systems referenced with respect to FIG. 1 of the present invention preferably include one or more computers 400 such as the one illustrated in FIG. 4.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method of creating a message using an accessibility service comprising the steps of:
receiving a request from a user to create a message for a target;
monitoring for one or more accessibility-signals;
in response to detecting one or more accessibility-signals, converting one or more of a plurality of received accessibility-signals into a text encoding; and
storing the text encoding as a message.

2. The method of claim 1, further comprising the step of storing an audio component of the message in response to failing to detect one or more accessibility-signals.

3. The method of claim 1, further comprising the steps of:
determining whether at least one of the user and the target subscribe to the accessibility service; and
processing the request to create a message with a service different than the accessibility service in response to a determination that neither the user nor the target subscribe to the accessibility service.

4. The method of claim 1, wherein the accessibility service includes a TTY service.

5. The method of claim 4, wherein the user accesses the unified messaging platform using VoIP, the method further comprising the steps of:
receiving a TTY message as a DTMF signal; and
converting the DTMF signal to an accessibility-signal encoded as an RTP event.

6. The method of claim 1, wherein the message is stored in an email.

7. A method of retrieving messages using an accessibility service comprising the steps of:
receiving a retrieval request for a message from a user;
determining whether the user is subscribed to the accessibility service;
retrieving the message from a storage device of the unified messaging platform;
determining whether the message is encoded in a format associated with the accessibility service;
rendering the encoded message based at least on the determination of whether the message is encoded in a format associated with the accessibility service and the determination of whether the user is subscribed to the accessibility service; and
transmitting the rendered message to the user.

8. The method of claim 7, further comprising the step of converting the message to an accessibility service encoded message in response to a determination that the message is not encoded in a format associated with the accessibility service.

9. The method of claim 8, further comprising the step of converting convert the message to an accessibility service encoded message using an automated speech recognition module.

10. The method of claim 8, wherein the step of converting the message to an accessibility service encoded message includes processing the message with a TTY dictionary.

11. The method of claim 7, further comprising the steps of rendering a first menu via accessibility service.

12. The method of claim 7, wherein the message includes and email.

13. The method of claim 7, wherein the accessibility service includes a TTY service.

14. A system for creating a message using an accessibility service comprising:
means for receiving a request from a user to create a message for a target;
means for monitoring for one or more accessibility-signals;
means for converting one or more of a plurality of received accessibility-signals into a text encoding in response to a detection of one or more accessibility-signals by the means for monitoring for one or more accessibility-signals; and
means for storing the text encoding as a message.

15. The system of claim 14, further comprising means for storing an audio component of the message in response to failing to detect one or more accessibility-signals.

16. The system of claim 14, further comprising:
means for determining whether at least one of the user and the target subscribe to the accessibility service; and
means for processing the request to create a message with a service different than the accessibility service in response to a determination that neither the user nor the target subscribe to the accessibility service.

17. The system of claim 14, wherein the accessibility service includes a TTY service.

18. A system for retrieving messages using an accessibility service comprising:
means for receiving a retrieval request for a message from a user;
means for determining whether the user is subscribed to accessibility service;
means for retrieving the message from a storage device;
means for determining whether the message is encoded in a format associated with the accessibility service;
means for rendering the retrieved message; and
means for transmitting the rendered message to the user.

19. The system of claim 18, further comprising means for converting the message to an accessibility service encoded message in response to determining that the message is not encoded in the format associated with the accessibility service.

20. The system of claim 19, further comprising means for converting speech to text, wherein the means for converting the message to an accessibility service encoded message utilizes the means for converting speech to text.

21. The system of claim 18, further comprising a means for rendering user-interactive menus via the accessibility service.

22. The system of claim 18, wherein the accessibility service includes a TTY service.
